(19) United States
(12) Patent Application Publication
(10) Pub. No.: US 2025/0086953 A1
(43) Pub. Date: Mar. 13, 2025

(54) ELECTRONIC DEVICE AND METHOD WITH BIRDS-EYE-VIEW IMAGE PROCESSING

(71) Applicant: SAMSUNG ELECTRONICS CO., LTD., Suwon-si (KR)

(72) Inventors: Xiaoshuai HAO, Beijing (KR); Yi ZHOU, Beijing (KR); Byung In YOO, Suwon-si (KR); Hui ZHANG, Beijing (KR); Seungin PARK, Suwon-si (KR); Sangil JUNG, Suwon-si (KR)

(73) Assignee: SAMSUNG ELECTRONICS CO., LTD., Suwon-si (KR)

(21) Appl. No.: 18/883,424

(22) Filed: Sep. 12, 2024

(30) Foreign Application Priority Data
Sep. 13, 2023 (CN) 202311183119.2
Jul. 19, 2024 (KR) 10-2024-0095939

(51) Int. Cl. G06V 10/80; G01S 17/86; G01S 17/89; G06V 10/44

(52) U.S. Cl. CPC G06V 10/806; G01S 17/86; G01S 17/89; G06V 10/44

(57) ABSTRACT

An image processing method is provided. The method includes obtaining a first bird's eye view (BEV) feature of first data, obtaining a second BEV feature of second data, inputting the first BEV feature and the second BEV feature to a self-attention network to obtain a third BEV feature of the first data and a fourth BEV feature of the second data, and obtaining a fusion feature in which the third BEV feature and the fourth BEV feature are fused, wherein the first data and the second data are collected by different sensors. Related operations of the examples provided by the present disclosure are implemented by an AI model. AI-related functions are performed by non-volatile memory, volatile memory, and a processor.

### CROSS-REFERENCE TO RELATED APPLICATIONS

This application claims the benefit under 35 USC § 119(a) of Chinese Patent Application No. 202311183119.2, filed on Sep. 13, 2023, in the China National Intellectual Property Administration, and Korean Patent Application No. 10-2024-0095939, filed on Jul. 19, 2024, in the Korean Intellectual Property Office, the entire disclosures of which are incorporated herein by reference for all purposes.

### BACKGROUND

### 1. Field

The following description relates to image signal processing, and more particularly, to technology that fuses bird's eye view (BEV) features of multi-modal data (or multi-modality data).

### 2. Description of Related Art

A high-definition (HD) map may provide rich and accurate information on a static environment of a driving scene, which is generally an important and difficult task in the designing an autonomous driving system. In one approach, construction of an HD map may involve predicting a set of vectorized static map elements from a bird's eye view (BEV), such as a crosswalk, a traffic lane, a road boundary, and the like.

Recently, a multimodal fusion method (e.g. fusing a camera-light detection modality and a ranging LiDAR modality) has been receiving attention in HD map construction tasks, and the method may greatly improve the baseline. Even when data of different modalities are mapped to an integrated BEV space, there is often a certain degree of semantic inconsistency between a LIDAR BEV feature and a corresponding camera BEV feature due to a large semantic difference between their different modalities, which may lead to a lack of semantic alignment, thereby causing degraded fusion performance. Thus, technology that may implement better fusion is needed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an image processing method performed by one or more processors includes obtaining a first bird's eye view (BEV) feature of first data of a first modality, obtaining a second BEV feature of second data of a second modality, inputting the first BEV feature and the second BEV feature to a self-attention network that, based on the first and second BEV features, generates a third BEV feature of the first data and a fourth BEV feature of the second data, and obtaining a fusion feature in which the third BEV feature and the fourth BEV feature are fused, wherein the first data is collected by a first sensor of the first modality and the second data is collected by a second sensor of the second modality.

The obtaining the third BEV feature of the first data and the fourth BEV feature of the second data may include obtaining a first feature matrix of the first data by flattening the first BEV feature based on a BEV channel and obtaining a second feature matrix of the second data by flattening the second BEV feature based on the BEV channel, obtaining a third feature matrix by concatenating the first feature matrix and the second feature matrix, and inputting the third feature matrix to the self-attention network to obtain the third BEV feature and the fourth BEV feature.

The obtaining the third BEV feature and the fourth BEV feature may include performing self-attention operations on the third feature matrix through the self-attention network, obtaining a concatenated feature vector by concatenating feature vectors output from the self-attention operations, obtaining a fourth feature matrix by non-linearly transforming the concatenated feature vector, and obtaining the third BEV feature and the fourth BEV feature based on the fourth feature matrix.

The performing of self-attention operations on the third feature matrix through the self-attention network may include obtaining a query vector, a key vector, and a value vector by performing linear transformations on the third feature matrix three times and obtaining a feature vector output by a corresponding self-attention operation by performing the plurality of self-attention operations based on the query vector, the key vector, and the value vector.

The obtaining of the fusion feature in which the third BEV feature and the fourth BEV feature are fused may include determining a first weight value corresponding to the third BEV feature and a second weight value corresponding to the fourth BEV feature and obtaining the fusion feature by performing fusion processing based on the third BEV feature, the first weight value, the fourth BEV feature, and the second weight value.

The determining of the first weight value and the second weight value may include obtaining a fused BEV feature in which the third BEV feature and the fourth BEV feature are fused, generating a pooling operation result of the fused BEV feature, and obtaining the first weight value and the second weight value based on the generated pooling operation result.

The obtaining of the first weight value and the second weight value based on the generated pooling operation result may include generating a first linear operation result by performing an operation to reduce a channel dimension of the generated pooling operation result, generating a second linear operation result by performing an operation to increase a channel dimension of the generated first linear operation result, and obtaining the first weight value and the second weight value based on the second linear operation result.

The obtaining of the fusion feature in which the third BEV feature and the fourth BEV feature are fused may include obtaining a concatenated feature by concatenating the third BEV feature weighted based on the first weight value and the fourth BEV feature weighted based on the second weight value according to a channel dimension, reducing a channel dimension of the concatenated feature, performing a pooling operation on the concatenated feature of which the channel dimension has been reduced, and obtaining the fusion feature based on the concatenated feature on which a pooling operation has been performed and based on the concatenated feature of which the channel dimension has been reduced.

In another general aspect, an image processing method performed by one or more processors includes obtaining a first bird's eye view (BEV) feature of first data, obtaining a second BEV feature of second data, and obtaining a fusion feature in which the first BEV feature and the second BEV feature are fused based on a first weight value corresponding to the first BEV feature and a second weight value corresponding to the second BEV feature, wherein the first data is derived from a first sensor of a first modality and the second data is derived from a second sensor of a second modality.

The obtaining of the fusion feature in which the first BEV feature and the second BEV feature are fused may include determining the first weight value and the second weight value and obtaining the fusion feature based on the first BEV feature, the first weight value, the second BEV feature, and the second weight value.

The determining of the first weight value and the second weight value may include fusing the first BEV feature with the second BEV feature, generating a pooling operation result of a result of fusing the first BEV feature with the second BEV feature, and obtaining the first weight value and the second weight value based on the generated pooling operation result.

The obtaining of the first weight value and the second weight value based on the generated pooling operation result may include generating a first linear operation result by performing an operation to reduce a channel dimension of the generated pooling operation result, generating a second linear operation result by performing an operation to increase a channel dimension of the generated first linear operation result, and obtaining the first weight value and the second weight value based on the second linear operation result.

The obtaining of the fusion feature in which the first BEV feature and the second BEV feature are fused may include obtaining a concatenated feature by concatenating the first BEV feature weighted based on the first weight value and the second BEV feature weighted based on the second weight value according to a channel dimension, reducing a channel dimension of the concatenated feature, performing a pooling operation on the concatenated feature of which the channel dimension has been reduced, and obtaining the fusion feature based on the concatenated feature on which a pooling operation has been performed and the concatenated feature of which the channel dimension has been reduced.

The obtaining of the fusion feature in which the first BEV feature and the second BEV feature are fused may further include inputting the first BEV feature and the second BEV feature to a self-attention network to obtain a third BEV feature of the first data and a fourth BEV feature of the second data and obtaining a fusion feature in which the third BEV feature and the fourth BEV feature are fused.

The obtaining the third BEV feature of the first data and the fourth BEV feature of the second data may include obtaining a first feature matrix of the first data by flattening the first BEV feature based on a BEV channel, obtaining a second feature matrix of the second data by flattening the second BEV feature based on the BEV channel, obtaining a third feature matrix by concatenating the first feature matrix and the second feature matrix, and inputting the third feature matrix to the self-attention network to obtain the third BEV feature and the fourth BEV feature.

The inputting of the third feature matrix to the self-attention network to obtain the third BEV feature and the fourth BEV feature may include performing self-attention operations on the third feature matrix through the self-attention network, obtaining a concatenated feature vector by concatenating feature vectors output from the self-attention operations, obtaining a fourth feature matrix by non-linearly transforming the concatenated feature vector, and obtaining the third BEV feature and the fourth BEV feature based on the fourth feature matrix.

The performing self-attention operations on the third feature matrix through the self-attention network may include obtaining a query vector, a key vector, and a value vector by performing linear transformations on the third feature matrix three times and obtaining a feature vector output by a corresponding self-attention operation by performing the self-attention operations based on the query vector, the key vector, and the value vector.

In another general aspect, an electronic device includes one or more processors and a memory storing instructions configured to cause the one or more processors to obtain a first bird's eye view (BEV) feature of first data of a first modality, obtain a second BEV feature of second data of a second modality, input the first BEV feature and the second BEV feature to a self-attention network to obtain a third BEV feature of the first data and a fourth BEV feature of the second data, and obtain a fusion feature in which the third BEV feature and the fourth BEV feature are fused, wherein the first data is collected by a first sensor of the first modality and the second data is collected by a second sensor of the second modality.

The instructions may be configured to cause the one or more processors to obtain a first feature matrix of the first data by flattening the first BEV feature based on a BEV channel, obtain a second feature matrix of the second data by flattening the second BEV feature based on the BEV channel, obtain a third feature matrix by concatenating the first feature matrix and the second feature matrix, and input the third feature matrix to the self-attention network to obtain the third BEV feature and the fourth BEV feature.

Other features and aspects will be apparent from the following detailed description, the drawings, and the claims.

### BRIEF DESCRIPTION OF THE DRAWINGS

FIG. 1 illustrates an example of bird's eye view (BEV) features of various modalities, according to one or more embodiments.

FIGS. 2A to 2C illustrate examples of a fusion method of a multi-modal BEV feature according to comparative examples.

FIG. 3 illustrates an example of an architecture for multi-modal BEV feature fusion of an electronic device, according to one or more embodiments.

FIG. 4 illustrates an example of an image processing method of an electronic device, according to one or more embodiments.

FIG. 5 illustrates an example of a dual branch dynamic fusion (DDF) model, according to one or more embodiments.

FIG. 6 illustrates an example of an image processing method, according to one or more embodiments.

FIGS. 7A to 7F illustrate an example of a qualitative image analysis result for generating a high-definition (HD) map image, according to one or more embodiments.

FIG. 8 illustrates an example configuration of an electronic device, according to one or more embodiments.

FIG. 9 illustrates an example of an electronic device, according to one or more embodiments.

FIG. 10 illustrates an image processing system, according to one or more embodiments.

FIG. 11 illustrates an example of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

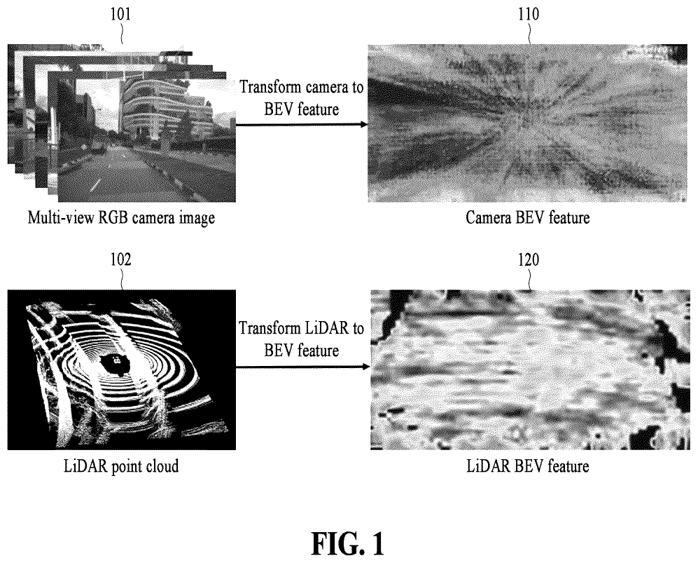

FIG. 1 illustrates an example of BEV features of various modalities extracted by comparative examples. As used herein, “comparative example” refers to a technology other than examples and embodiments described in detail herein (which are not referred to as “comparative examples”). Comparative examples herein are generally technologies preceding the examples and embodiments described herein and may be referenced to highlight improvements and advantages of the examples and embodiments described herein.

In discussing the comparative examples, a vector value corresponding to a BEV feature may be extracted from a camera image 101. The vector value extracted from the camera image 101 may be referred to herein as a camera BEV feature 110. In addition, in discussing the comparative examples, a vector value corresponding to a BEV feature may be extracted from a light detection and ranging (LiDAR) point cloud 102 sensed using LiDAR. The vector value extracted from the LiDAR point cloud 102 may be referred to as a LIDAR BEV feature 120. Specifically, in the comparative examples, the camera BEV feature 110 may be extracted as a two-dimensional (2D) vector (e.g., (i,j)), and the LiDAR BEV feature 120 may also be extracted as a 2D vector. A same BEV space may represent a case in which the camera BEV feature 110 and the LiDAR BEV feature 120 extracted by the comparative examples are vectors of a same dimensionality. Even when the camera BEV feature 110 and the LiDAR BEV feature 120 are vectors of a same corresponding real world feature and are of the same dimension (e.g., a 2D vector or a three-dimensional (3D) vector), a distance between the camera BEV feature 110 and the LiDAR BEV feature 120 may be great, and the camera BEV feature 110 and the LiDAR BEV feature 120 may thus have a large modality gap. In other words, as shown in FIG. 1, even though the camera BEV feature 110 and the LiDAR BEV feature 120 may be in the same BEV space, the camera BEV feature 110 and the LiDAR BEV feature 120 may be semantically inconsistent to some extent due to the large modality gap. In addition, since the multi-modality fusion method according to the comparative example may directly perform an arithmetic operation or a stitching operation on a multi-modal BEV feature, a semantic inconsistency issue may occur and fusion performance may also be affected.

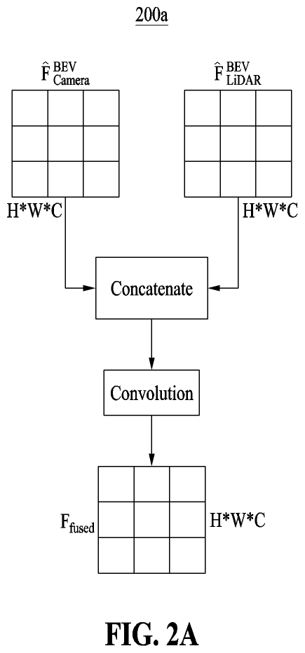

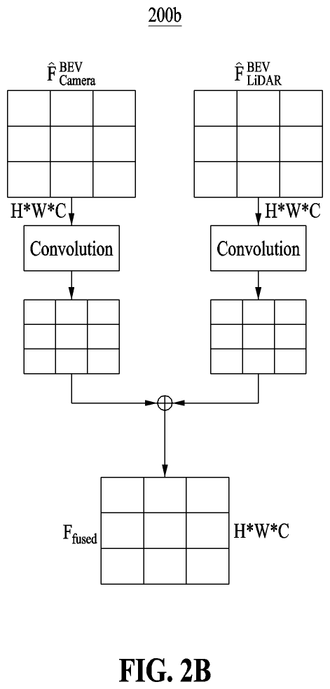

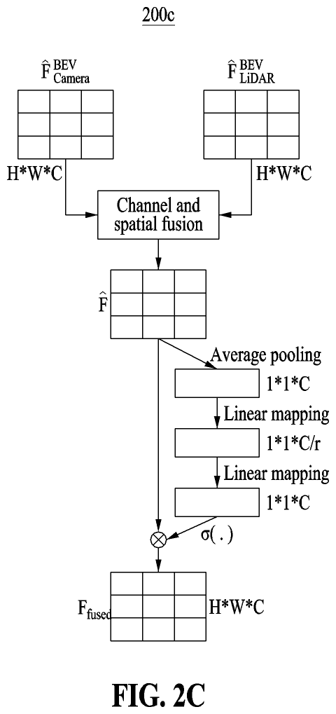

FIGS. 2A to 2C illustrate examples of a fusion network of a multi-modal BEV feature according to comparative examples, according to one or more embodiments.

FIG. 2A illustrates a convolutional fusion method of a multi-modal BEV feature based on a neural network 200a according to a comparative example. The neural network 200a may first concatenate BEV features (e.g., \hat{F}_{Camera}^{BEV}, \hat{F}_{LiDAR}^{BEV}) of different modalities in series and then fuse the BEV features of the different modalities using a convolution operation to obtain a fusion BEV feature (e.g., F_{fused}) and construct a high-precision feature map.

FIG. 2B illustrates a summation fusion method for obtaining a multi-modal BEV feature (e.g. F_{fused}) based on a neural network 200b according to a comparative example. The network 200b may perform convolution operation on different BEV features (e.g., \hat{F}_{Camera}^{BEV}, \hat{F}_{LiDAR}^{BEV}) using a convolutional network and may subsequently add convolution features to obtain a fusion BEV feature (e.g., F_{fused}) and construct a high-precision map.

FIG. 2C illustrates a dynamic fusion method of a multi-modal BEV feature based on a neural network 200c according to a comparative example. The neural network 200c may first concatenate BEV features (e.g., \hat{F}_{Camera}^{BEV}, \hat{F}_{LiDAR}^{REV}) from different modalities and fuse the BEV features from the different modalities into a learnable static weight. The dynamic fusion method of multi-modal BEV features through the neural network 200c is inspired by the Squeeze-and-Excitation mechanism and may select important fusion features using a simple channel attention module.

Among the three fusion methods through the neural networks 200a, 200b, and 200c according to the comparative examples, the convolutional fusion method of FIG. 2A may be used for a high-precision map reconstruction task, and the methods of FIGS. 2B and 2C may be used for a 3D target/object detection field.

The fusion methods of different modalities through the networks 200a, 200b, and 200c according to the comparative examples may have the following two main issues.

Firstly, despite being in the same BEV space, LiDAR BEV features (e.g. \hat{F}_{LiDAR}^{BEV} of FIG. 2A, \hat{F}_{LiDAR}^{BEV} of FIG. 2B, and \hat{F}_{LiDAR}^{BEV} of FIG. 2C) and camera BEV features (e.g. \hat{F}_{Camera}^{BEV} of FIG. 2A \hat{F}_{Camera}^{BEV} of FIG. 2B, and \hat{F}_{Camera}^{BEV} of FIG. 2B, and \hat{F}_{Camera}^{BEV} of FIG. 2C) may be semantically inconsistent to some extent due to a large modality gap. In addition, since the fusion methods of different modalities through the neural networks 200a, 200b, and 200c according to the comparative examples may directly perform an arithmetic operation or a stitching operation on multi-modal BEV features, a semantic inconsistency issue may occur and fusion performance may also be affected.

Secondly, since the multi-modal BEV feature fusion methods through the neural networks 200a, 200b, and 200c according to the comparative examples may fuse the BEV features of the different modalities through a very simple fusion operation, an information loss issue may occur.

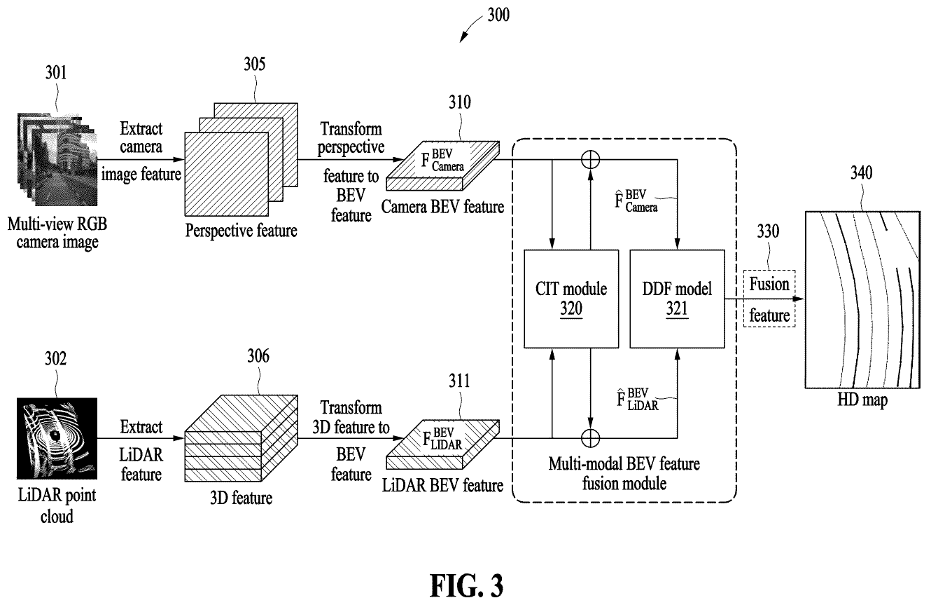

FIG. 3 illustrates an example of an architecture for multi-modal BEV feature fusion of an electronic device, according to one or more embodiments.

As shown in FIG. 3, an electronic device 300 may extract a feature (e.g., a perspective feature 305 or a 3D feature 306) from multi-modal data (e.g., a camera image 301 and a LiDAR image 302) obtained from sensors of different modalities and may transform (e.g., embed) the extracted feature to a BEV feature (e.g., a camera BEV feature 310 or a LiDAR BEV feature 311) of a shared BEV space using a view transformer (not shown). In order to fuse BEV features of either modality (e.g., the camera BEV feature 310 or the LiDAR BEV feature 311), the electronic device 300 may use a cross-modal interaction transform (CIT) module 320 and may augment one modality from another modality through a cross-attention mechanism of the CIT module 320.

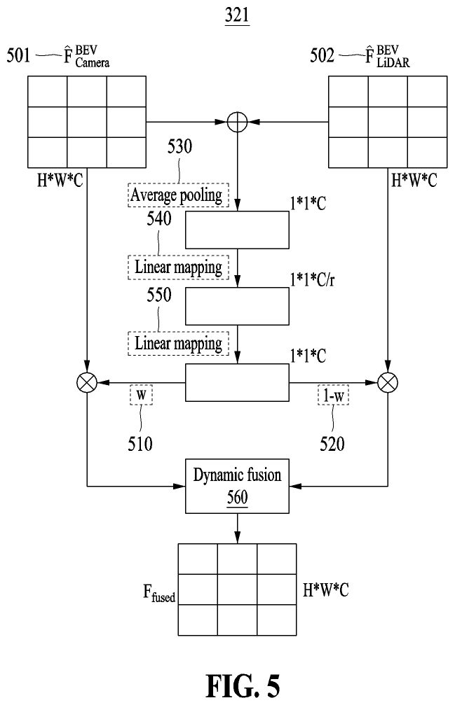

In addition, the electronic device 300 may utilize a dual-branch dynamic fusion (DDF) model 321 to automatically select valuable/significant information from different modalities for better feature fusion. The DDF model 321 is described with reference to FIG. 5.

Finally, the electronic device 300 may construct an HD map 340 by inputting a fused multi-modal BEV feature 330 to a detector (not shown) and a prediction head (not shown).

Although FIG. 3 illustrates using both the CIT module 320 and the DDF model 321 to fuse multi-modal BEV features (e.g., the camera BEV feature 310 or the LiDAR BEV feature 311), examples and embodiments described herein are not limited thereto. For example, depending on application and implementation details, the electronic device 300 may achieve better feature fusion by utilizing information between different modalities using only the CIT module 320 or only the DDF model 321.

In addition, although FIG. 3 illustrates fusing the multi-view camera image 301 and the LiDAR image 302, one of ordinary skill in the art will understand that various data (e.g., an image or text) may be fused and the feature fusion is not limited to using data of only the modalities mainly described herein, e.g., the camera image 301 and the LiDAR image 302.

### First Example

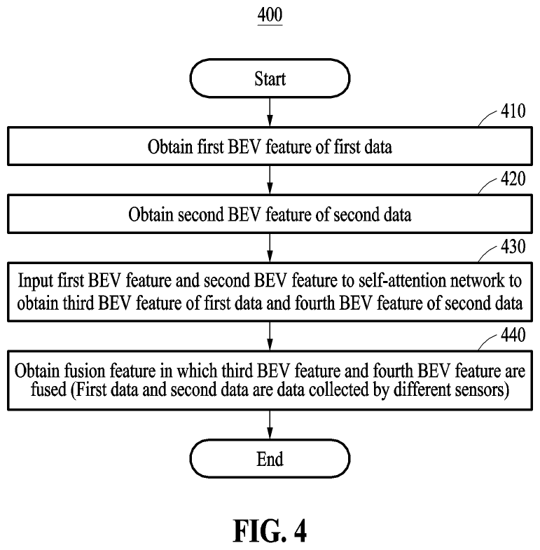

FIG. 4 illustrates an example of an image processing method 400 of an electronic device, according to one or more embodiments.

As shown in FIG. 4, a first BEV feature of first data may be obtained in operation 410 of the image processing method 400 performed by the electronic device.

In operation 420, the electronic device may obtain a second BEV feature of second data.

In operation 430, the electronic device may input the first BEV feature and the second BEV feature to a self-attention network to obtain a third BEV feature (which is a BEV feature of the first data) and a fourth BEV feature (which is BEV feature of the second data).

In operation 440, the electronic device may obtain a fusion feature in which the third BEV feature and the fourth BEV feature are fused. The first data and the second data may be data collected by sensors, possibility of different modalities.

The data collected by different sensors may be referred to herein as data of different modalities. The first data may be data of a camera image, and the second data may be data of a LIDAR image such as a LiDAR point cloud.

Hereinafter, the description is given regarding a case in which the first data corresponds to a camera image and the second data corresponds to a LiDAR image, but the type of data is not limited thereto in this specification. For example, instead of the LiDAR image, any sensed point cloud data may be used.

Accordingly, the electronic device may significantly improve data fusion performance by sufficiently (or more fully) utilizing information between different data and/or information between different modalities.

For ease of description, some symbols and definitions used in this specification are first introduced.

It is assumed that multi-modal sensor data (χ) is used as an input and a vectorized map element of a BEV space is predicted. For example, each element in a set of map elements may be classified as a road boundary, a traffic lane, or a crosswalk. A multi-modal input χ={Camera, LiDAR} may include a multi-view red, green, and blue (RGB) camera image (e.g., Camera) and a LiDAR point cloud (e.g., LiDAR) of a perspective view. In addition, the multi-modal input χ={Camera, LiDAR} may satisfy Camera∈R^{N}^{^{cam}}^{×H}^{^{cam}}^{×W}^{^{cam}}^{×3}, where N^{cam}, H^{cam}, and W^{cam} represent a number of cameras, an image height, and an image width, respectively. In addition, the multi-modal input may satisfy LiDAR∈R^{P×5}, where P is a number of points, and where each point consists of 3D coordinates, reflectance, and a ring index (the “5” in “P×5”).

The electronic device may extract a camera BEV feature of the camera image and a LiDAR BEV feature of the LiDAR image in operations 410 and 420, respectively. In other words, the camera BEV feature of the camera image may serve as the first BEV feature, and the LiDAR BEV feature of the LiDAR image may serve as the second BEV feature.

As described next, the electronic device may perform a method for multi-feature fusion-based high-precision map construction based on a Map Transformer (MapTR) model. For example, the electronic device (e.g., the electronic device 300 of FIG. 3) may output an initial feature (e.g., the perspective feature 305 and the 3D feature 306 of FIG. 3) from two respective sensor inputs (e.g., the camera image 301 and the LiDAR image 302 of FIG. 3). The electronic device may encode a semantic feature of a pixel level in an image perspective view by applying 2D-3D conversion to the camera image 301. First, the electronic device may extract F_{Camera}^{PV} (e.g., the perspective feature 305 of FIG. 3) from Camera∈R^{N}^{^{cam}}^{×H}^{^{cam}}^{×W}^{^{cam}}^{×3}, which may be each input image (e.g., the camera image 301) through 2D convolution. The electronic device (e.g., the electronic device 300 of FIG. 3) may predict a depth distribution of “D” equidistant scatter points related to each pixel of the input image (e.g., the camera image 301). Here, D may be 512 or another value, and the scattered points may correspond one-to-one with pixels of the image (e.g., the camera image 301). For example, the electronic device may predict the depth distribution in each of 512 different pixels arranged at a same distance from a pixel located in the center of the input image (e.g., the camera image 301). For example, the depth distribution may include distance from a camera that captured the input image (e.g., the camera image 301) to a real object corresponding to a corresponding pixel. However, examples are not limited thereto. Next, the electronic device (e.g., the electronic device 300 of FIG. 3) may obtain D×H×W F_{Camera}^{3D} (e.g., a pseudo-point cloud feature) by assigning F_{Camera}^{PV} (e.g., the perspective feature 305 of FIG. 3) to the “D” equidistant scatter points in a camera ray direction. Finally, the electronic device (e.g., the electronic device 300 of FIG. 3) may obtain the camera BEV feature F_{Camera}^{BEV}∈R^{H×W×C} (e.g., the camera BEV feature 310 of FIG. 3) by flattening the pseudo-point cloud feature into the BEV space through pooling. Here, C denotes a number of channels and may be 512. The electronic device may extract the LiDAR BEV feature 311 extracted from the LiDAR image 302 (e.g., the LiDAR point cloud). For example, the electronic device may extract the LiDAR BEV feature 311 based on sparsely embedded convolutional detection (SECOND) model that uses a voxelized and sparse LiDAR encoder on the LiDAR image 302. The electronic device may project the LiDAR BEV feature 311 to the BEV space using a flatten operation of a BEV fusion model to express the LiDAR BEV feature 311 F_{LiDAR}^{BEV}∈R^{H×W×C} (e.g., the LiDAR BEV feature 311 of FIG. 3) in a same vector space as the camera BEV feature 310.

In the network (e.g., FIGS. 2A to 2C) according to the comparative examples, all sensor features may be directly transformed to shared BEV features and fused through an arithmetic operation or a stitching operation to obtain a multi-modal BEV feature. However, despite being in the same BEV space, a certain degree of semantic misalignment may occur due to a large gap between the LiDAR BEV feature and the camera BEV feature, resulting in a semantic misalignment issue.

In contrast, the electronic device (e.g., the electronic device 300 of FIG. 3) may include a CIT module (e.g., the CIT module 320 of FIG. 3) that augments one modality from another modality through a cross-attention mechanism. For reference, in FIG. 3, the data output from the CIT module 320 of the electronic device 300 and the data input to the DDF model 321 are depicted as being divided into an information line related to the camera image 301 and an information line related to the LiDAR image 302. However, this is only expressed as conceptual distinction for understanding. Data obtained from the CIT module 320 may be data in which information related to the camera image 301 and information related to the LiDAR image 302 are fused (or connected or combined), and the same may apply to data input to the DDF model 321. A data operation method based on the CIT module 320 and the DDF model 321 is described in detail below with reference to FIGS. 4 and 5.

In operation 430, the electronic device may use the CIT module (e.g., the CIT module 320 of FIG. 3) to obtain the third BEV feature of the first data and the fourth BEV feature of the second data through the self-attention network, based on the first BEV feature and the second BEV feature.

First, the electronic device (e.g., the electronic device 300 of FIG. 3) may obtain a new camera feature matrix T_{Camera}^{BEV}∈R^{HW×C} (e.g., a first feature matrix) and a new LiDAR feature matrix T_{LiDAR}^{BEV}∈R^{HW×C} (e.g., a second feature matrix) by flattening and sorting an order of the camera BEV feature F_{Camera}^{BEV}∈R^{H×W×C} (e.g., the first BEV feature) and the LiDAR BEV feature F_{LiDAR}^{BEV}∈R^{H×W×C} (e.g., the second BEV feature) based on a BEV channel. Each of the feature matrices may be a token matrix. The electronic device may subsequently concatenate token matrices of two modalities and add learnable positional embedding. The positional embedding may be a learnable parameter of 2HW×C dimensions, which may allow a model to distinguish spatial information between different token matrices during training. This way, the electronic device may obtain one input token matrix Tⁱⁿ∈R^{2HW×C}. In other words, the electronic device may obtain, from the CIT module, the input token matrix Tⁱⁿ including information corresponding to the first BEV feature and information corresponding to the second BEV feature. Thereafter, the electronic device may apply a self-attention operation at least one time to the input token matrix Tⁱⁿ.

For example, as shown in Equation 1 below, the electronic device may calculate a set (Q, K, V) of a query (Q) vector, a key (K) vector, and a value (V) vector through linear projection (e.g., a cubic linear transformation) onto the input token matrix Tⁱⁿ in each self-attention operation applied to the input token matrix Tⁱⁿ. Here, in an attention mechanism, a query vector, a key vector, and a value vector are three basic vector representations used to describe an input sequence, calculate similarity, and output weight information, respectively.

$$Q = {T}^{i n} {W}^{Q} , K = {T}^{i n} {W}^{K} , V = {T}^{i n} {W}^{V} \qquad Equation 1$$

In Equation 1, W^{Q}∈R^{C×D}^{_{Q}},·W^{K}∈R^{C×D}^{_{K}}, ·W^{V}∈R^{C×D}^{_{V}} is a weight matrix, and in the CIT module (e.g., the CIT module 320 of FIG. 3), D_{Q}, D_{K}, and D_{V} may be the same. For example, D_{Q}=D_{K}=D_{V}=C may be satisfied.

Thereafter, the electronic device may obtain a feature vector, which may be an output of the self-attention operation, by applying the self-attention operation to Q, K, and V. Specifically, as shown in Equation 2 below, the electronic device may calculate an attention weight using a scaled dot product between Q and K in a self-attention layer, and by subsequently multiplying the attention weight by a V value to infer a refined output Z.

$$Z = Attention ( Q , K , V ) = softmax ( \frac{{QK}^{T}}{\sqrt{{D}_{k}}} ) V \qquad Equation 2$$

In Equation 2,

$$\frac{1}{\sqrt{{D}_{k}}}$$

is a scaling factor intended to prevent the slope of the softmax function from falling into an extremely small area when the size of the dot product increases.

As shown in Equation 3 below, a multi-head attention mechanism may be used to encapsulate multiple complex relationships in different representation subspaces at different locations.

$$\hat{Z} = Multihead ( Q , K , V ) = Concat ( {Z}_{1} , … , {Z}_{h} ) {W}^{o} , \qquad Equation 3$$

$${Z}_{i} = Attention ( {QW}_{i}^{Q} , {KW}_{i}^{K} , {VW}_{i}^{V} )$$

In Equation 3, the subscript h indicates a number of heads, W⁰∈R^{h·C×C} denotes a projection matrix of Concat(Z₁ , . . . , Zₕ), and i denotes an index of each self-attention operation.

Generally, a self-attention model establishes an interaction between different types of input vectors (e.g. token matrices) in one linear projection space. Multi-head attention refers to setting different projection information in several different projection spaces, projecting an input matrix (e.g., a token matrix) differently to obtain multiple output matrices, and stitching together and/or concatenating the output matrices.

The electronic device may obtain a concatenated feature vector by applying a self-attention operation at least one time (e.g., i times, i is a natural number greater than or equal to 1) to the input token matrix (e.g., Tⁱⁿ) and concatenating feature vectors of each output.

Finally, the electronic device may calculate an output token matrix (e.g., T^{out}) using a non-linear transformation in the CIT module. A tensor shape of the output token matrix calculated by the electronic device (e.g., T^{out}) may be identical to a tensor shape of the input token matrix (e.g., Tⁱⁿ). For example, when the tensor shape of the input token matrix is an (M×N) matrix, the tensor shape of the output token matrix may also be an (M×N) matrix. The output token matrix may be calculated based on Equation 4 below. In Equation 4, MLP( ) denotes a multilayer perceptron.

$${T}^{o u t} = M L P ( \hat{Z} ) + {T}^{i n} \qquad Equation 4$$

In Equation 4, an output T^{out} is transformed, for feature fusion, to an updated camera BEV feature \hat{F}_{Camera}^{BEV} (e.g., the third BEV feature) and an updated LiDAR BEV feature \hat{F}_{LiDAR}^{BEV} (e.g., the fourth BEV feature). For example, the electronic device may transform the output T^{out} to \hat{F}_{Camera}^{BEV} and \hat{F}_{LIDAR}^{BEV} based on an inverse operation to separate the output T^{out} in which \hat{F}_{Camera}^{BEV} and \hat{F}_{LiDAR}^{BEV} are concatenated.

A core idea of the CIT module is to combine global information of a camera mode and a LiDAR mode using a self-attention mechanism, since the camera mode and the LiDAR mode are complementary to each other. Specifically, the electronic device may assign a weight to each position of the multi-modal BEV features that are input using a correlation matrix through the CIT module. Consequently, the electronic device may automatically and simultaneously perform intra-modal and inter-modal information fusion based on the CIT module and may reliably capture the complementary information inherent between the BEV features of different modalities.

The electronic device may implement a better fusion feature by fusing the updated camera BEV feature \hat{F}_{Camera}^{BEV} with the updated LiDAR BEV feature \hat{F}_{LiDAR}^{BEV}.

In operation 440, the electronic device may obtain a fusion feature that has the updated camera BEV feature (e.g., the third BEV feature) fused with the updated LiDAR BEV feature (e.g., the fourth BEV feature). For example, in addition to utilizing the CIT module to effectively improve a fusion effect, the electronic device may also employ an effective cross-modal fusion strategy to appropriately select valuable information from different modalities to eventually achieve better feature fusion. For example, in order to be inspired by the Squeeze-and-Excitation mechanism and efficiently select valuable information from different modalities, the electronic device may use a DDF model (e.g., the DDF model 321 of FIG. 3) for better feature fusion and maximum performance improvement.

Hereinafter, the DDF model is described with an example in which the electronic device inputs the updated camera \hat{F}_{Camera}^{BEV} feature (e.g., the third BEV feature) and the updated LiDAR BEV feature \hat{F}_{LiDAR}^{BEV} (e.g., the fourth BEV feature) to the DDF model. However, the input to the DDF model may be the camera BEV feature F_{Camera}^{BEV} (e.g., the first BEV feature) and the LiDAR BEV feature F_{LiDAR}^{BEV} (e.g., the second BEV feature).

FIG. 5 illustrates an example of a DDF model, according to one or more embodiments.

As shown in FIG. 5, the electronic device may input a set of two features, the camera BEV feature and the LiDAR BEV feature, to the DDF model 321. For example, the electronic device may input an updated camera BEV feature 501 (e.g., \hat{F}_{Camera}^{BEV}) and an updated LiDAR BEV feature 502 (e.g., \hat{F}_{LiDAR}^{BEV}) to the DDF model 321. To generate a meaningful attention weight that may efficiently select an information feature from the two inputs, the updated camera BEV feature 501 and the updated LiDAR BEV feature 502, the electronic device may first determine a first weight value corresponding to the updated camera BEV feature 501 and a second weight value corresponding to the updated LiDAR BEV feature 502.

Specifically, as shown in Equation 5 below, the electronic device may produce a result of a pooling operation by fusing (e.g., summing) and pooling features of two branches before performing a Squeeze-and-Excitation operation on the attention weight.

$$w = σ ( γ ( Avgpool ( {\hat{F}}_{Camera}^{BEV} + {\hat{F}}_{LiDAR}^{BEV} ) ) ) \qquad Equation 5$$

In Equation 5, σ and γ denote a sigmoid function and a linear layer, respectively, and w denotes the attention weight.

Thereafter, the electronic device may perform fusion processing based on the updated camera BEV feature 501, a first weight value 510, the updated LiDAR BEV feature 502, and a second weight value 520 to obtain a fusion feature (e.g., F_{fused}). Specifically, the electronic device may multiply the two previous input features (e.g., the updated camera BEV feature 501 and the updated LiDAR BEV feature 502) by the first weight value 510 (e.g., w) and the second weight value 520 (e.g., 1−w) respectively, to obtain a weighted camera BEV feature and a weighted LiDAR BEV feature. For example, the electronic device may multiply the updated camera BEV feature 501 by w and multiply the updated LiDAR BEV feature 502 by 1−w.

As shown in FIG. 5, when calculating the first weight value 510 and the second weight value 520, the electronic device may fuse the updated camera BEV feature 501 with the updated LiDAR BEV feature 502, perform pooling 530 (e.g., average pooling) on a resulting fused BEV feature, and obtain the first weight value 510 (e.g., w) and the second weight value 520 (e.g., 1−w) based on a resulting pooled feature.

The electronic device may reduce the channel dimension by performing a first linear operation 540 (e.g., linear mapping) on the pooled feature based on the pooled feature. For example, the electronic device may reduce the channel dimension of the pooled feature down to C/r. Here, r may be set according to design requirements. For example, r may be set to 4. The electronic device may increase the channel dimension by performing a second linear operation 550 (e.g., linear mapping) on a feature obtained after performing the first linear operation 540 to obtain the first weight value 510 and the second weight value 520.

Thereafter, the electronic device may perform dynamic fusion 560 (e.g., summation) on the weighted camera BEV feature and the weighted LiDAR BEV feature to obtain the fusion feature (e.g., F_{fused}). Here, the dynamic fusion 560 may be configured to operate as a self-attention mechanism that may adaptively select useful information from various BEV features, as shown in Equation 6 below.

$${F}_{fused} = {F}_{adaptive} ( {f}_{concat} ( [ w ( {\hat{F}}_{Camera}^{BEV} ) , ( 1 - w ) {\hat{F}}_{LiDAR}^{BEV} ] ) ) \qquad Equation 6$$

In Equation 6, |⋅, ⋅| indicates that the electronic device performing a serial and/or concatenate operation according to the channel dimension to obtain a concatenated feature. f_{concat} denotes a static channel and spatial fusion function implemented as a 3×3 convolution layer and may be used to reduce the channel dimension of the concatenate feature. For example, the electronic device may reduce the channel dimension down to C. When an input feature \hat{F}=R^{H×W×C} is given, a formula f_{adaptive} may be as Equation 7 below.

$${f}_{adaptive} ( \hat{F} ) = σ ( W {f}_{avg} ( \hat{F} ) ) \cdot \hat{F} \qquad Equation 7$$

In Equation 7, W denotes a linear transformation matrix (e.g., 1×1 convolution), f_{avg} denotes global average pooling, and σ denotes a sigmoid function.

In sum, the electronic device may pool a concatenated feature of a reduced dimension and obtain a fusion feature based on a pooled concatenated feature and the concatenated feature of the reduced dimension.

Accordingly, the DDF model 321 of the electronic device may adaptively select valuable information from the two modalities for better feature fusion.

The output fusion feature (e.g., (e. g., F_{fused})) may be used for a high-precision map construction task.

However, in operation 440, the electronic device may not only perform feature fusion based on the DDF model 321 described with reference to FIG. 5 above, but also fuse the updated camera BEV feature with the updated LiDAR BEV feature using the method shown in FIGS. 2A to 2C. For example, as the convolutional fusion method shown in FIG. 2A, the electronic device may concatenate the updated camera BEV feature \hat{F}_{Camera}^{BEV} and the updated LiDAR BEV feature \hat{F}_{LiDAR}^{BEV} in series and may fuse the multi-modal BEV features by performing convolution to obtain fusion feature F_{fused}. Alternatively, as the summation fusion method shown in FIG. 2B, the electronic device may perform convolution on the BEV features \hat{F}_{Camera} and \hat{F}_{LiDAR}^{BEV} of different modalities using a convolutional neural network (CNN) and sum up convolution features to obtain F_{fused}. Alternatively, as the dynamic fusion method shown in FIG. 2C, the electronic device may use output features of the convolutional fusion method as an input to fuse the output features with a learnable static weight.

In addition, the electronic device may perform model training. For example, the electronic device may train a model based on a loss function consisting of a classification loss [symbol] _{cls}, a point-to-point loss [symbol] ₚ₂ₚ, and an edge-direction loss [symbol] _{dir} according to a map transformer (MapTR) model. When the loss terms are combined, an overall objective function may be expressed as Equation 8 below.

$$ℒ = {λ}_{1} {ℒ}_{cls} + {λ}_{2} {ℒ}_{p 2 p} + {λ}_{3} {ℒ}_{dir} \qquad Equation 8$$

In Equation 8, λ₁, λ₂ and λ₃ may be hyperparameters. The electronic device may update parameters of an entire network through a stochastic gradient descent (SGD) algorithm and a chain rule.

The training stated above may be referred to as offline training.

### Second Example

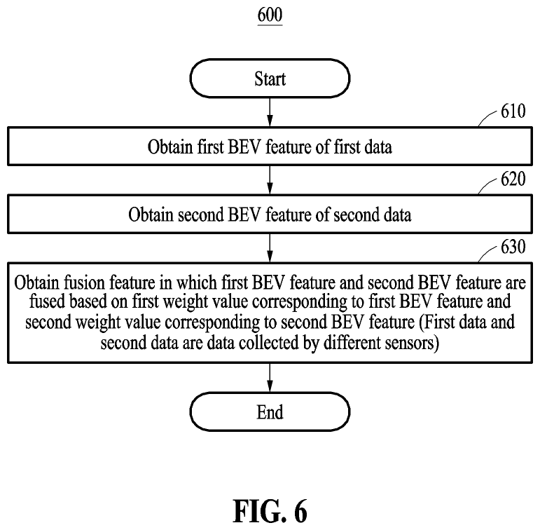

FIG. 6 illustrates a flowchart of an example of an image processing method 600, according to one or more embodiments.

As shown in FIG. 6, in operation 610 of the image processing method 600, an electronic device may obtain a first BEV feature of first data.

In operation 620, the electronic device may obtain a second BEV feature of second data.

In operation 630, the electronic device may obtain a fusion feature in which the first BEV feature and the second BEV feature are fused based on a first weight value corresponding to the first BEV feature and a second weight value corresponding to the second BEV feature. Here, the first data and the second data may represent data collected by different sensors.

Accordingly, the electronic device may achieve significant performance improvement by sufficiently utilizing (e.g., exchanging) information between different modalities.

Operations 610 and 620 may be generally the same as operations 410 and 420 described with reference to FIG. 4, respectively, except that the electronic device may input a camera BEV feature (F_{Camera}^{BEV}) and a LiDAR BEV feature F_{LiDAR}^{BEV} to a DDF model and may not input an updated camera BEV feature \hat{F}_{Camera}^{BEV} and an updated LiDAR BEV feature \hat{F}_{LiDAR}^{BEV} to the DDF model; operation 630 may be similar to the process described with reference to FIG. 5.

Thus, a fusion effect of multi-modal BEV features may be improved even when the electronic device only uses the DDF model.

Multi-modal feature extraction and model training of the electronic device may be generally the same as the multi-modal feature extraction and model training according to the first example disclosed above.

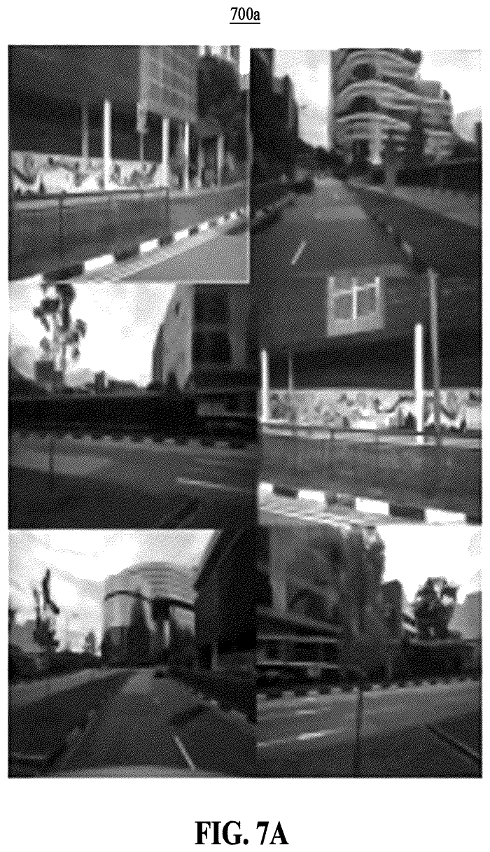

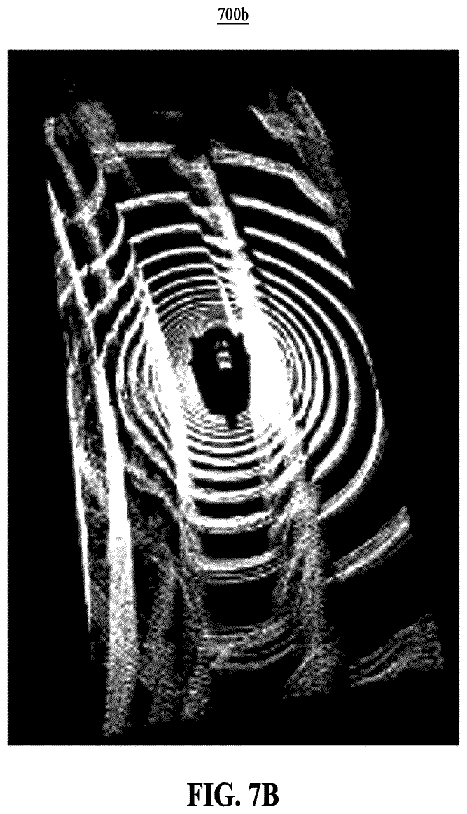

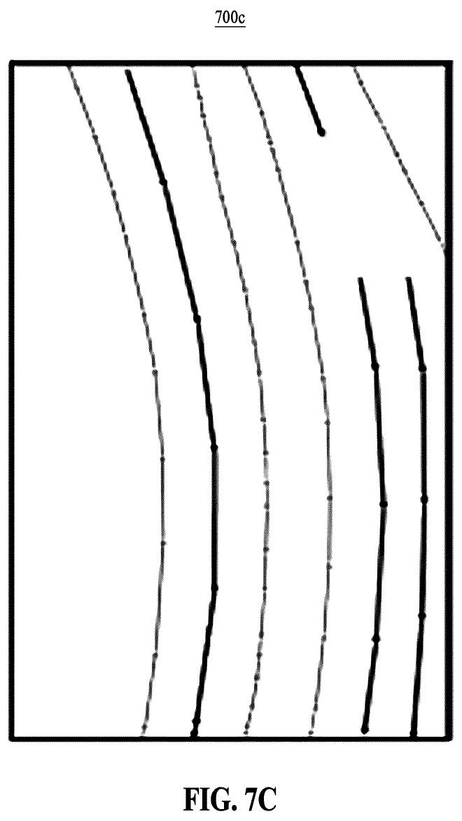

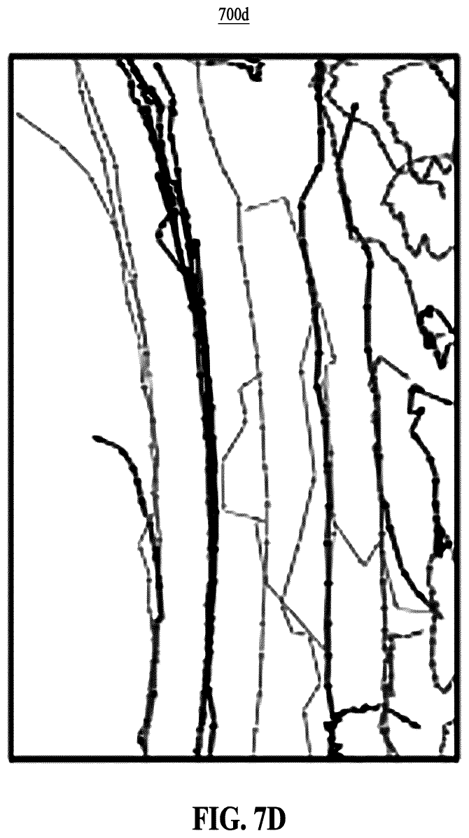

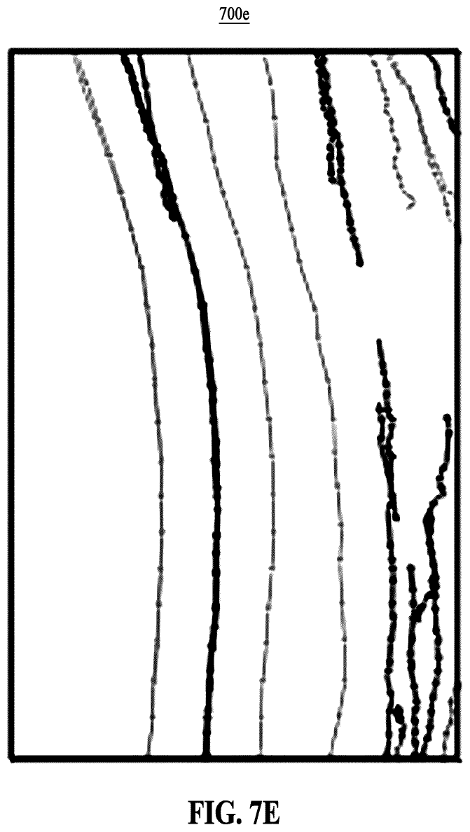

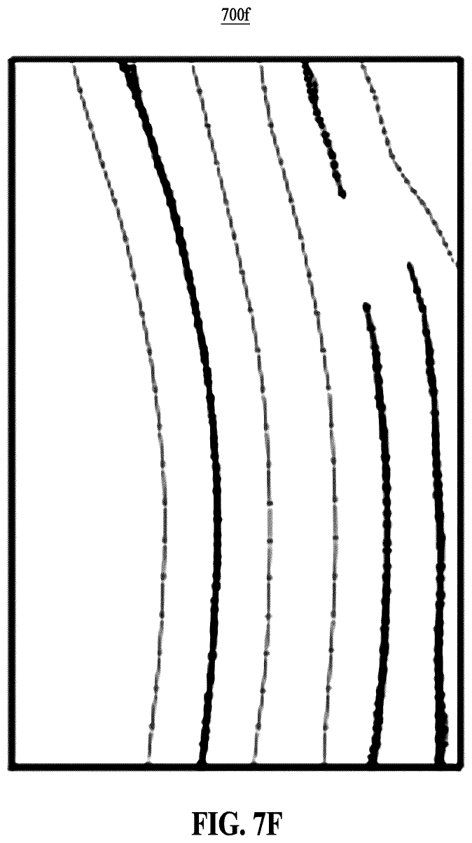

FIGS. 7A to 7F illustrate an example of a qualitative image analysis result for generating a high-definition (HD) map image, according to one or more embodiments.

FIGS. 7A to 7F illustrate an example in which an electronic device generates an HD map image based on a NuScenes data set. FIGS. 7A to 7F illustrate some example images among images included in the NuScenes data set. Here, the NuScenes data set includes 1,000 pieces of image data taken while driving in an area known to be a traffic congested area.

FIG. 7A illustrates an example of six camera images included in the NuScenes data set. FIG. 7B illustrates an example of a LiDAR point cloud. FIG. 7C illustrates an example of an actual BEV HD map vectorized based on FIGS. 7A and 7B. FIG. 7D illustrates an example of a prediction result of an HD map generated using a MapTR model based on FIGS. 7A and 7B. FIG. 7E illustrates an example of a BEV HD map vectorized using only a CIT module included in the electronic device. FIG. 7F illustrates an example of a BEV HD map vectorized based on an MBFusion model (e.g., a configuration including both a CIT module and a DDF model) included in the electronic device.

In FIG. 7D, it may be confirmed that a prediction result of an HD map generated using the MapTR model, which is a basic model, may have a very large error compared to FIG. 7E or 7F. Based on FIG. 7E, it may be confirmed that the electronic device may correct a serious error in a basic prediction by using the CIT module, and based on FIG. 7F, it may be confirmed that the electronic device may improve accuracy by using the entire MBFusion model.

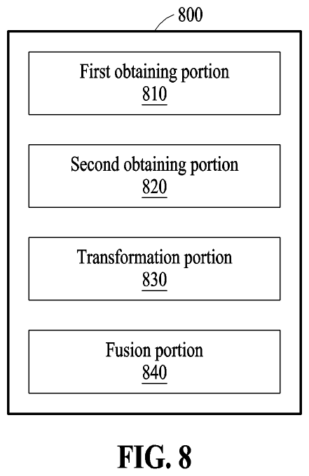

FIG. 8 illustrates an example of an electronic device 800, according to one or more embodiments. The electronic device 800 may be a terminal, a server, or any other device.

As shown in FIG. 8, the electronic device 800 may include a first obtaining portion 810, a second obtaining portion 820, a transformation portion 830, and a fusion portion 840.

The first obtaining portion 810 may be configured to obtain a first BEV feature of first data.

The second obtaining portion 820 may be configured to obtain a second BEV feature of second data.

The transformation portion 830 may be configured to obtain a third BEV feature of the first data and a fourth BEV feature of the second data through a self-attention network, based on the first BEV feature and the second BEV feature.

The fusion portion 840 may be configured to obtain a fusion feature by fusing the third BEV feature with the fourth BEV feature. Here, the first data and the second data may be data collected by sensors with different respective modalities.

The transformation portion 830 may obtain a first feature matrix of the first data by flattening the first BEV feature based on a BEV channel. In addition, the transformation portion 830 may obtain a second feature matrix of the second data by flattening the second BEV feature based on the BEV channel. The transformation portion 830 may be configured to concatenate the first feature matrix and the second feature matrix to obtain a third feature matrix, and to obtain, through a self-attention network, the third BEV feature and the fourth BEV feature based on the third feature matrix.

The transformation portion 830 may apply a self-attention operation through a self-attention network to the third feature matrix at least one time, may obtain a concatenated feature vector by concatenating feature vectors output from each self-attention operation, and may be configured to obtain a fourth feature matrix by non-linearly transforming the concatenated feature vector and to obtain the third BEV feature and the fourth BEV feature based on the fourth feature matrix.

In an example implementation, each self-attention operation may include an operation of performing linear transformations on the third feature matrix three times, for example, to obtain a query vector, a key vector, and a value vector, respectively and an operation of applying a self-attention operation to the query vector, the key vector, and the value vector to obtain a feature vector output by a corresponding self-attention operation.

In an example implementation, the fusion portion 840 may be configured to determine a first weight value corresponding to the third BEV feature and a second weight value corresponding to the fourth BEV feature and to obtain a fusion feature by performing fusion processing based on the third BEV feature, the first weight value, the fourth BEV feature, and the second weight value.

In an example, the fusion portion 840 may be configured to fuse the third BEV feature with the fourth BEV feature, to perform pooling on the fused BEV feature, and to obtain the first weight value and the second weight value based on the pooled feature.

In an example, the fusion portion 840 may be configured to perform a first linear operation on the pooled feature by reducing a channel dimension, to perform a second linear operation to increase a channel dimension on the feature after the first linear operation is performed, and to obtain the first weight value and the second weight value based on the feature after the second linear operation is performed.

In an example, the fusion portion 840 may be configured to obtain a concatenated feature by concatenating the third BEV feature weighted using the first weight value and the fourth BEV feature weighted using the second weight value according to a channel dimension, to reduce a channel dimension of the concatenated feature, to pool the concatenated feature with a reduced channel dimension, and to obtain a fusion feature based on the pooled concatenate feature and the concatenate feature with a reduced channel dimension.

In an example, the fusion feature may be used for high-precision map reconstruction.

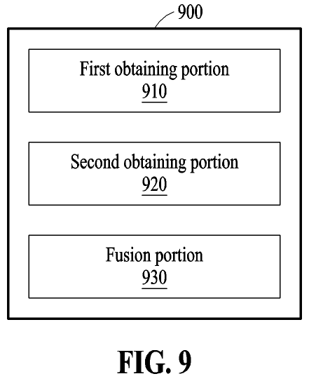

FIG. 9 illustrates an example of an electronic device 900, according to one or more embodiments. The electronic device 900 may be a terminal, a server, or any other device.

As shown in FIG. 9, the electronic device 900 may include a first obtaining portion 910, a second obtaining portion 920, and a fusion portion 930.

The first obtaining portion 910 may be configured to obtain a first BEV feature of first data.

The second obtaining portion 920 may be configured to obtain a second BEV feature of second data.

The fusion unit 930 may be configured to obtain a fusion feature in which the first BEV feature and the second BEV feature are fused based on a first weight value corresponding to the first BEV feature and a second weight value corresponding to the second BEV feature. Here, the first data and the second data may be data collected by different sensors.

In an example, the fusion portion 930 may be configured to determine the first weight value corresponding to the first BEV feature and the second weight value corresponding to the second BEV feature and to obtain the fusion feature by performing fusion processing based on the first BEV feature, the first weight value, the second BEV feature, and the second weight value.

In an example, the fusion portion 930 may be configured to fuse the first BEV feature and the second BEV feature, to perform pooling on the fused BEV feature, and to obtain the first weight value and the second weight value based on the pooled feature.

In an example, the fusion portion 930 may be configured to perform a first linear operation to reduce a channel dimension on the pooled feature, to perform a second linear operation to increase a channel dimension on the feature after the first linear operation is performed, and to obtain the first weight value and the second weight value based on the feature after the second linear operation is performed.

In an example, the fusion portion 840 may be configured to obtain a concatenated feature by concatenating the third BEV feature weighted using the first weight value and the fourth BEV feature weighted using the second weight value according to a channel dimension, to reduce a channel dimension of the concatenated feature, to pool the concatenated feature with a reduced channel dimension, and to obtain a fusion feature based on the pooled concatenate feature and the concatenated feature with a reduced channel dimension.

In an example, the electronic device 900 may further include a transformation portion (not shown) configured to obtain a third BEV feature of the first data and a fourth BEV feature of the second data through a self-attention network based on the first BEV feature and the second BEV feature. The fusion portion 930 may be further configured to obtain the fusion feature by fusing the third BEV feature with the fourth BEV feature.

In an example, a transformation portion (not shown) may be configured to obtain a first feature matrix of the first data by flattening the first BEV feature based on a BEV channel, to obtain a second feature matrix by flattening the second BEV feature based on the BEV channel, to obtain a third feature matrix by concatenating the first feature matrix and the second feature matrix, and to obtain a third BEV feature and a fourth BEV feature through a self-attention network based on the third feature matrix.

In an example, the transformation portion (not shown) may be configured to apply a self-attention operation through a self-attention network to the third feature matrix at least one time, to obtain a concatenate feature vector by concatenating feature vectors output from each self-attention operation, to obtain a fourth feature matrix by non-linearly transforming the concatenated feature vector, and to obtain the third BEV feature and the fourth BEV feature based on the fourth feature matrix.

In an example, each self-attention operation may perform linear transformations on the third feature matrix three times, for example, to obtain a query vector, a key vector, and a value vector, respectively and may apply a self-attention operation to the query vector, the key vector, and the value vector to obtain a feature vector output by a corresponding self-attention operation.

A fusion feature may be used for high-precision map reconstruction.

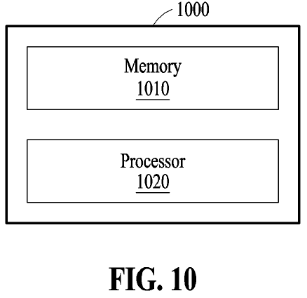

FIG. 10 illustrates an example of an image processing system 1000, according to one or more embodiments.

As shown in FIG. 10, the electronic system 1000 may include a memory 1010 and a processor 1020.

The memory 1010 may be configured to store instructions.

The processor 1020 (in practice, one or more processors of any combination of processor types) may be coupled to the memory 1010 and configured to execute instructions to cause the electronic system 1000 to perform a method among the methods described above.

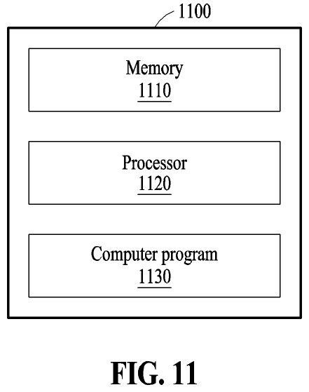

FIG. 11 illustrates an example of an electronic device 1100, according to one or more embodiments. The electronic device 1100 may be a terminal, a server, or any other device.

As shown in FIG. 11, the electronic device 1100 may include a memory 1110, a processor 1120, and a computer program 1130 stored in the memory 1110, and the processor 1120 may run the computer program 1130 to implement a method among the methods described above.

A computer-readable storage medium may store a computer program (instructions), wherein the computer program may, when executed by a processor, implement the audio (or image) signal processing methods.

At least one module may be implemented through an AI model. An AI-related function may be performed by a non-volatile memory, a volatile memory, and a processor.

The processor 1120 may include one or more processors. Here, the one or more processors may be, for example, a general-purpose processor (e.g., a central processing unit (CPU), an application processor (AP), etc.) or a graphics-dedicated processing unit (e.g., a graphics processing unit (GPU), a vision processing unit (VPU)) and/or an AI-dedicated processor (e.g., a neural processing unit (NPU)).

The one or more processors may control processing of input data according to the AI model or a predefined operation rule stored in the non-volatile memory and the volatile memory. The predefined operation rule or the AI model may be provided through training or learning.

Providing the predefined operation rule or the AI model through learning may involve obtaining a predefined operation rule or an AI model having desired characteristics by applying a learning algorithm to a plurality of pieces of training data. The training may be performed by an apparatus itself in which AI is performed according to an example and/or by a separate server/apparatus/system.

The AI model may include neural network layers. Each layer may have multiple weight values and may perform a neural network calculation by calculating between input data of that layer (e.g., a calculation result of a previous layer and/or input data of the AI model) and weight values of a current layer. A neural network may be/include, for example, a CNN, a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q network, as non-limiting examples.

The learning algorithm may be a method of training a predetermined target device, for example, a robot, based on pieces of training data and of enabling, allowing, or controlling the target device to perform determination or prediction. The learning algorithm may include, for example, supervised learning, unsupervised learning, semi-supervised learning, or reinforcement learning. However, examples are not limited thereto.

The examples described herein may be implemented using hardware components, software components (instructions), and/or combinations thereof. A processing device may be implemented using one or more general-purpose or special-purpose computers, such as, for example, a processor, a controller, an arithmetic logic unit (ALU), a digital signal processor (DSP), a microcomputer, a field-programmable gate array (FPGA), a programmable logic unit (PLU), a microprocessor or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is used as singular. However, one of ordinary skill in the art will appreciate that a processing device may include multiple processing elements and/or multiple types of processing elements. For example, a processing device may include a plurality of processors, or a single processor and a single controller. In addition, a different processing configuration is possible, such as one including parallel processors.

The software (instructions) may include a computer program, a piece of code, an instruction, or a combination thereof, to independently or collectively instruct or configure the processing device to operate as desired. The software and/or data may be permanently or temporarily embodied in any type of machine, component, physical or virtual equipment, or computer storage medium or device for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The computing apparatuses, the electronic devices, the processors, the memories, the sensors, the vehicle/operation function hardware, the assisted/automated driving systems, the displays, the information output system and hardware, the storage devices, and other apparatuses, devices, units, modules, and components described herein with respect to FIGS. 1-11 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-11 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RW, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An image processing method performed by one or more processors, the method comprising:
obtaining a first bird's eye view (BEV) feature of first data of a first modality;
obtaining a second BEV feature of second data of a second modality;
inputting the first BEV feature and the second BEV feature to a self-attention network that, based on the first and second BEV features, generates a third BEV feature of the first data and a fourth BEV feature of the second data; and
obtaining a fusion feature in which the third BEV feature and the fourth BEV feature are fused,
wherein the first data is collected by a first sensor of the first modality and the second data is collected by a second sensor of the second modality.

2. The method of claim 1, wherein the obtaining the third BEV feature of the first data and the fourth BEV feature of the second data comprises:
obtaining a first feature matrix of the first data by flattening the first BEV feature based on a BEV channel;
obtaining a second feature matrix of the second data by flattening the second BEV feature based on the BEV channel;
obtaining a third feature matrix by concatenating the first feature matrix and the second feature matrix; and
inputting the third feature matrix to the self-attention network to obtain the third BEV feature and the fourth BEV feature.

3. The method of claim 2, wherein the obtaining the third BEV feature and the fourth BEV feature comprises:
performing self-attention operations on the third feature matrix through the self-attention network;
obtaining a concatenated feature vector by concatenating feature vectors output from the self-attention operations;
obtaining a fourth feature matrix by transforming the concatenated feature vector; and
obtaining the third BEV feature and the fourth BEV feature based on the fourth feature matrix.

4. The method of claim 3, wherein the performing of the self-attention operations on the third feature matrix through the self-attention network comprises:
obtaining a query vector, a key vector, and a value vector by performing linear transformations on the third feature matrix three times; and
obtaining a feature vector output by a corresponding self-attention operation by performing the self-attention operations based on the query vector, the key vector, and the value vector.

5. The method of claim 1, wherein the obtaining of the fusion feature in which the third BEV feature and the fourth BEV feature are fused comprises:
determining a first weight value corresponding to the third BEV feature and a second weight value corresponding to the fourth BEV feature; and
obtaining the fusion feature by performing fusion processing based on the third BEV feature, the first weight value, the fourth BEV feature, and the second weight value.

6. The method of claim 5, wherein the determining of the first weight value and the second weight value comprises:
obtaining a fused BEV feature in which the third BEV feature and the fourth BEV feature are fused;
generating a pooling operation result of the fused BEV feature; and
obtaining the first weight value and the second weight value based on the generated pooling operation result.

7. The method of claim 6, wherein the obtaining of the first weight value and the second weight value based on the generated pooling operation result comprises:
generating a first linear operation result by performing an operation to reduce a channel dimension of the generated pooling operation result;
generating a second linear operation result by performing an operation to increase a channel dimension of the generated first linear operation result; and
obtaining the first weight value and the second weight value based on the second linear operation result.

8. The method of claim 5, wherein the obtaining of the fusion feature in which the third BEV feature and the fourth BEV feature are fused comprises:
obtaining a concatenated feature by concatenating the third BEV feature weighted based on the first weight value and the fourth BEV feature weighted based on the second weight value according to a channel dimension;
reducing a channel dimension of the concatenated feature;
performing a pooling operation on the concatenated feature of which the channel dimension has been reduced; and
obtaining the fusion feature based on the concatenated feature on which a pooling operation has been performed and based on the concatenated feature of which the channel dimension has been reduced.

9. An image processing method performed by one or more processors, the method comprising:
obtaining a first bird's eye view (BEV) feature of first data;
obtaining a second BEV feature of second data; and
obtaining a fusion feature in which the first BEV feature and the second BEV feature are fused based on a first weight value corresponding to the first BEV feature and a second weight value corresponding to the second BEV feature,
wherein the first data is derived from a first sensor of a first modality and the second data is derived from a second sensor of a second modality.

10. The method of claim 9, wherein the obtaining of the fusion feature in which the first BEV feature and the second BEV feature are fused comprises:
determining the first weight value and the second weight value; and
obtaining the fusion feature based on the first BEV feature, the first weight value, the second BEV feature, and the second weight value.

11. The method of claim 10, wherein the determining of the first weight value and the second weight value comprises:
fusing the first BEV feature with the second BEV feature;
generating a pooling operation result of a result of fusing the first BEV feature with the second BEV feature; and
obtaining the first weight value and the second weight value based on the generated pooling operation result.

12. The method of claim 11, wherein the obtaining of the first weight value and the second weight value based on the generated pooling operation result comprises:
generating a first linear operation result by performing an operation to reduce a channel dimension of the generated pooling operation result;
generating a second linear operation result by performing an operation to increase a channel dimension of the generated first linear operation result; and
obtaining the first weight value and the second weight value based on the second linear operation result.

13. The method of claim 12, wherein the obtaining of the fusion feature in which the first BEV feature and the second BEV feature are fused comprises:
obtaining a concatenated feature by concatenating the first BEV feature weighted based on the first weight value and the second BEV feature weighted based on the second weight value according to a channel dimension;
reducing a channel dimension of the concatenated feature;
performing a pooling operation on the concatenated feature of which the channel dimension has been reduced; and
obtaining the fusion feature based on the concatenated feature on which a pooling operation has been performed and based on the concatenated feature of which the channel dimension has been reduced.

14. The method of claim 9, wherein the obtaining of the fusion feature in which the first BEV feature and the second BEV feature are fused further comprises:
inputting the first BEV feature and the second BEV feature to a self-attention network to obtain a third BEV feature of the first data and a fourth BEV feature of the second data; and
obtaining a fusion feature in which the third BEV feature and the fourth BEV feature are fused.

15. The method of claim 14, wherein the obtaining the third BEV feature of the first data and the fourth BEV feature of the second data comprises:
obtaining a first feature matrix of the first data by flattening the first BEV feature based on a BEV channel;
obtaining a second feature matrix of the second data by flattening the second BEV feature based on the BEV channel;
obtaining a third feature matrix by concatenating the first feature matrix and the second feature matrix; and
inputting the third feature matrix to the self-attention network to obtain the third BEV feature and the fourth BEV feature.

16. The method of claim 15, wherein the inputting of the third feature matrix to the self-attention network to obtain the third BEV feature and the fourth BEV feature comprises:
performing self-attention operations on the third feature matrix through the self-attention network;
obtaining a concatenated feature vector by concatenating feature vectors output from the self-attention operations;
obtaining a fourth feature matrix by non-linearly transforming the concatenated feature vector; and
obtaining the third BEV feature and the fourth BEV feature based on the fourth feature matrix.

17. The method of claim 16, wherein the performing of the self-attention operations on the third feature matrix through the self-attention network comprises:
obtaining a query vector, a key vector, and a value vector by performing linear transformations on the third feature matrix three times; and
obtaining a feature vector output by a corresponding self-attention operation by performing the self-attention operations based on the query vector, the key vector, and the value vector.

18. A non-transitory computer-readable storage medium storing instructions that, when executed by a processor, cause the processor to perform the method of claim 9.

19. An electronic device comprising:
one or more processors; and
a memory storing instructions configured to cause the one or more processors to:
obtain a first bird's eye view (BEV) feature of first data of a first modality;
obtain a second BEV feature of second data of a second modality;
input the first BEV feature and the second BEV feature to a self-attention network to obtain a third BEV feature of the first data and a fourth BEV feature of the second data; and
obtain a fusion feature in which the third BEV feature and the fourth BEV feature are fused,
wherein the first data is collected by a first sensor of the first modality and the second data is collected by a second sensor of the second modality.

20. The electronic device of claim 19, wherein the instructions are further configured to cause the one or more processors to:
obtain a first feature matrix of the first data by flattening the first BEV feature based on a BEV channel;
obtain a second feature matrix of the second data by flattening the second BEV feature based on the BEV channel;
obtain a third feature matrix by concatenating the first feature matrix and the second feature matrix; and
input the third feature matrix to the self-attention network to obtain the third BEV feature and the fourth BEV feature.
